(19) United States
(12) Patent Application Publication
(10) Pub. No.: US 2007/0184376 A1
(43) Pub. Date: Aug. 9, 2007

(54) Method of preparing electrophotographic developer

(75) Inventors: Duck hee Lee, Seoul (KR); Seok-hoon Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/602,281

(22) Filed: Nov. 21, 2006

(30) Foreign Application Priority Data
Feb. 4, 2006 (KR) 10-2006-0010918

(51) Int. Cl. G03G 9/09

(52) U.S. Cl. 430/109.1; 430/137.1; 430/137.18

(57) ABSTRACT

A method of preparing a nonmagnetic one-component pulverized color electrophotographic developer, includes: preparing a master batch by melt-kneading at least two binder resins and wax; and melt-kneading a mixture of the master batch, a colorant, and a charge control agent. According to the method, paper jams can be decreased and a toner having wide fixing margin can be obtained by preventing wax from being dispersed mainly in a resin having a similar melting property as wax during melt-kneading to prepare a toner. An electrophotographic developer prepared using the method can prevent image contamination and developing member contamination. Also, the electrophotographic developer can guarantee wide fixing margin of the toner, and thus can be efficiently used in an electrophotographic image forming apparatus.

### CROSS-REFERENCE TO RELATED PATENT APPLICATION

This application claims the benefit under 35 U.S.C. § 119(a) of Korean Patent Application No. 10-2006-0010918, filed on Feb. 4, 2006, in the Korean Intellectual Property Office, the disclosure of which is hereby incorporated by reference in its entirety.

### BACKGROUND OF THE INVENTION

1. Field of the Invention

The present invention relates to a method of preparing an electrophotographic developer. More particularly, the invention is directed to a method of preparing a pulverizing color electrophotographic developer by melt-kneading at least two binder resins and wax.

2. Description of the Related Art

Electrophotographic image processing apparatuses, such as laser printers, facsimiles, copying machines, are nowadays widely used. Such an apparatus forms a desired image by forming a latent image on a photoreceptor by utilizing a laser, moving a toner onto the latent image on the photoreceptor by using an electrical potential difference, and then transferring a toner image onto a printing media such as a paper.

Recently, an image forming apparatus, such as a laser beam printer (LBP) for electrophotographs, a multifunction machine, a color copying machine, etc. is widely used and the requirements for printing high quality images have increased. In the case of a color laser printer, toners of four standard colors (cyan, magenta, yellow, black), are used. In this case, red can be expressed by mixing magenta and yellow, and thus a thicker toner layer is formed than in the case where a monocolor toner is used. The color laser printer requires better image fixability than a monocolor laser printer to maintain such a thicker toner layer fixed to a toner image. Also, to reduce the amount of used paper, more users desire to print on both sides of paper. In this case, however, paper jam occurs more frequently than in the case of single-sided printing.

To address these problems, a master batch is prepared using at least two binder resins, different kinds of waxes, or a binder resin and wax. However, the use of the above solutions is limited due to image contamination caused by un-dispersed wax in a binder resin or a narrow fixing margin.

Accordingly, there is a continuing need in the industry for an improved method of preparing toner compositions.

### SUMMARY OF THE INVENTION

The present invention provides a method of preparing an electrophotographic developer which inhibits or prevents image contamination and developing member contamination. The developer also provides a fixing margin of a toner by preparing a master batch using at least two binder resins and wax to improve dispersibility of wax in the binder resins.

The present invention also provides an electrophotographic developer prepared using the method and an electrophotographic image forming apparatus employing the electrophotographic developer.

According to an aspect of the present invention, there is provided a method of preparing a nonmagnetic one-component pulverizing color electrophotographic developer, including: preparing a master batch by melt-kneading at least two binder resins and wax; and melt-kneading a mixture of the master batch, a colorant, and a charge control agent.

The binder resin may include one of polystyrene, styrene based copolymer, polymethylmethacrylate, polyethylmethacrylate, polybutylmethacrylate, a copolymer thereof, polyvinyl chloride, polyvinyl acetate, polyethylene, polypropylene, polyester, polyurethane, polyamide, epoxy resin, polyvinylbutyral resin, rosin, modified rosin, terpene resin, and phenol resin.

The at least two binder resins may be of the same kind or different kinds.

The at least two binder resins may include two different kinds of resins, wherein the ratio of the two binder resins may be about 1:9 to about 9:1 by weight.

Glass transition temperatures of the at least two binder resins may be the same or different.

The at least two binder resins may include two resins having different glass transition temperatures, wherein the ratio of the two binder resins may be about 1:9 to about 9:1 by weight.

The wax may include one of a polypropylene series, a polyethylene series, an ester series, a paraffin series, and carnauba wax.

The melting point of the wax may be in the range of about 70 to 90° C.

The amount of wax, used in the preparing of the master batch, may be in the range of about 1 to 10 parts by weight based on the 100 parts by weight of the binder resin used in the master batch.

The melt-kneading temperature in melt-kneading a preparing of the master batch may be lower than the softening point of the binder resins and higher than the melting point of the wax.

The melt-kneading temperature of the mixture may be lower than the softening point of the master batch and higher than the melting point of the wax.

The colorant may include one of yellow, magenta, cyan, and black pigments.

According to another aspect of the present invention, there is provided an electrophotographic developer is prepared using the method of preparing a nonmagnetic one-component pulverizing color electrophotographic developer, the method including: preparing a master batch by melt-kneading at least two binder resins and wax; and melt-kneading a mixture of the master batch, a colorant, and a charge control agent.

According to another aspect of the present invention, there is provided an electrophotographic image forming apparatus employing the electrophotographic developer prepared using the above method.

The electrophotographic developer prepared according to the method of the present invention has improved qualities for preventing image contamination and developing member contamination prevention, and wide fixing margin of a toner due to uniform dispersibilities of a binder resin and wax.

These and other aspects of the invention will become apparent from the following detailed description of the invention.

### BRIEF DESCRIPTION OF THE DRAWING

The above and other features and advantages of the present invention will become more apparent by describing in detail exemplary embodiments thereof with reference to the attached drawing in which:

FIG. 1 is a schematic diagram of a non-contact developing type image forming apparatus employing a toner prepared using a method according to an embodiment of the present invention.

### DETAILED DESCRIPTION OF THE INVENTION

According to an embodiment of the present invention, a method of preparing a nonmagnetic one-component pulverized color electrophotographic developer is provided, including: preparing a master batch by melt-kneading at least two binder resins and wax; and melt-kneading a mixture of the master batch, a colorant, and a charge control agent. According to the current embodiment, cold offset during fixation at a low temperature, hot offset during fixation at a high temperature, and wrap jam in a fusing device can be prevented.

The method of the current embodiment is for preparing a pulverized color dry toner as a developer for an electrophotographic image processing apparatus, such as a laser printer, a facsimile, a copying machine, and the like. The method prepares a master batch by melt-kneading at least two binder resins and wax to solve problems of the prior methods such as inferior image quality due to un-dispersed wax or non-uniform dispersion of wax, developing member contamination, inferior fixability of toner, and the like.

Various known resins can be used as the binder resin. Examples of the binder resin include polystyrene, poly-p-chlorostyrene, poly-a-methylstyrene, styrene based copolymer such as styrene-chlorostyrene copolymer, styrene-propylene copolymer, styrene-vinyltoluene copolymer, styrene-vinylnaphthalene copolymer, styrene-methylacrylate copolymer, styrene-ethylacrylate copolymer, styrene-propylacrylate copolymer, styrene-butylacrylate copolymer, styrene-octylacrylate copolymer, styrene-methylmethacrylate copolymer, styrene-ethylmethacrylate copolymer, styrene-propylmethacrylate copolymer, styrene-butylmethacrylate copolymer, styrene-α-chloromethylmethacrylate copolymer, styrene-acrylonitrile copolymer, styrene-vinylmethylether copolymer, styrene-vinylethylether copolymer, styrene-vinylethylketone copolymer, styrene-butadiene copolymer, styrene-acrylonitrile-indene copolymer, styrene-maleic acid copolymer, and styrene-maleic ester; polymethylmethacrylate, polyethylmethacrylate, polybutylmethacrylate, and a copolymer thereof, polyvinyl chloride, polyvinyl acetate, polyethylene, polypropylene, polyester, polyurethane, polyamide, epoxy resin, polyvinylbutyral resin, rosin, modified rosin, terpene resin, phenol resin, aliphatic or alicyclic hydrocarbon resin, aromatic petroleum resin, chlorinated paraffin and paraffin wax, and the like, or a combination thereof. The binding resin may be used alone or as a mixture of two or more. Among them, polyester resin has an excellent fixability and transparency and is suitable for use in a color developer.

The at least two binder resins used in the method of the current embodiment may be of the same kind or different kinds. When the at least two binder resins are different, the amount of the two binder resins may be in a ratio of about 1:9 to about 9:1 by weight.

The glass transition temperature of the at least two binder resins may be the same of different. When the at least two binder resins have different glass transition temperatures, the amount of the two resins may be in a ratio of about 1:9 to about 9:1 by weight.

The wax can be classified into one of polypropylene series, polyethylene series, ester series, paraffin series, carnauba wax (natural wax,) and the like. Low melting point wax having a melting point in the range of about 70 to 90° C. may be used. When the melting point is less than 70° C. or more than 90° C., properties of the master batch may deteriorate due to stress while preparing the master batch. In the current embodiment, the master batch is prepared with the binder resins and the wax because esters, paraffins and carnauba wax as low melting point waxes may not knead well due to low viscosity and wax may not disperse well when at least two binder resins are used.

When at least two binder resins are melt-kneaded together, the mixing efficiency of the binder resins deteriorate due to different melting temperatures of the binder resins. Accordingly, before the melt-kneading of the mixture, that is, before mixing the master batch, the colorant, and the charge control agent, at least two binder resins are mixed to prepare a master batch. Thus, the mixing efficiency is improved because at least two binder resins can be used as if they were one resin.

However, when only the at least two binder resins are melt-kneaded, it is difficult to blend a mixture of resins having all the properties of the binder resins and dispersion of wax in the master batch. Thus, in the current embodiment, the wax is added while preparing a master batch of the binder resins. Hence, dispersibility of the wax in the binder resins and blending efficiency of the binder resins are increased by preventing the wax from being dispersed mainly in the binder resins having similar melting properties as the wax during the melt-kneading of the mixture.

The developer may include a colorant that may be carbon black or aniline black in the case of a black toner. Also, it is easy to produce a color nonmagnetic toner according to an embodiment of the present invention. In the case of a color toner, carbon black is used as a colorant for black, and a yellow colorant, a magenta colorant, and a cyan colorant are further included as colorants for the colors.

The yellow colorant may be a condensed nitrogen compound, an isoindolinone compound, an anthraquinone compound, an azo metal complex, or an aryl imide compound. For example, C.I. pigment yellow 12, 13, 14, 17, 62, 74, 83, 93, 94, 95, 109, 110, 111, 128, 129, 147, 168, and the like, may be used.

The magenta colorant may be a condensed nitrogen compound, anthraquinone, a quinacridone compound, a lake pigment of basic dye, a naphthol compound, a benzoimidazole compound, a thioindigo compound, or a perylene compound. For example, C.I. pigment red 2, 3, 5, 6, 7, 23, 48:2, 48:3, 48:4, 57:1, 81:1, 144, 146, 166, 169, 177, 184, 185, 202, 206, 220, 221, 254, and the like, may be used.

The cyan colorant may be a copper phthalocyanine compound or a derivative thereof, an anthraquinone compound, or a lake pigment of basic dye. For example, C.I. pigment blue 1, 7, 15, 15:1, 15:2, 15:3, 15:4, 60, 62, 66, and the like, may be used.

These colorants may be used alone or in combinations of two or more types. A desired colorant is selected considering color, saturation, brightness, weatherability, and dispersability in a toner.

The amount of the colorant may be sufficient to dye a toner and form a visible image by development. In one example, the colorant is in the range of about 2-20 parts by weight, based on 100 parts by weight of the binder resin. If the amount of the colorant is less than 2 parts by weight, sufficient coloring effects cannot be attained. If the amount of the colorant is more than 20 parts by weight, the electrical resistance of the toner is reduced and sufficient frictional charge cannot be obtained, thus causing image contamination.

The charge control agent used in the electrophotographic developer according to the current embodiment may be a negative-charge control agent or a positive-charge control agent. Examples of the negative-charge control agent include an organic metal complex, such as a chromium-containing azo dye or monoazo metal complex, or a chelating compound; a salicylic compound containing metal, such as chromium, iron, or zinc; and an organic metal complex with aromatic hydroxycarboxilic acid or aromatic dicarboxylic acid, being not limited thereto. Examples of the positive-charge control agent include a product modified with nigrosine and its fatty acid metal salt, and the like, and an onium salt containing a quaternary ammonium salt, such as tributylbenzylammonium 1-hydroxy-4-naphthosulfonate and tetrabutylammonium tetrafluoroborate; or a combination thereof. The charge control agent may be used alone or in a mixture of two or more. The charge control agent ensures that the toner is stably supported on the developing roller by an electrostatic force, thereby allowing for a stable and rapid charging speed.

The amount of the charge control agent in the toner composition is generally in a range of 0.1-10 parts by weight, based on 100 parts by weight of the untreated parent toner particles.

The colorant may be previously flushing-treated or used as a melt-kneaded master batch to ensure a uniform dispersion in the binder resin. For example, not only the binder resin and the low melting point wax, but also the colorant may be mixed using a kneading device, such as a 2-roll, a 3-roll, a press kneader, a twin-screw extruder, etc. The colorant must be uniformly dispersed in the mixture and the melt-kneading is performed at 80-180° C. for 10 minutes to 2 hours. Then, the mixture is pulverized using a pulverizer, for example, a jet mill, an attritor mill, a rotary mill, and the like, to produce the toner particles having an average particle size of about 3-15 μm. The external additives are attached to the toner particles to improve powder mobility and charging stability of the toner particles.

Another embodiment of the present invention provides an electrophotographic image forming apparatus employing an electrophotographic developer prepared by a method of preparing a nonmagnetic one-component pulverizing color electrophotographic developer, the method including: preparing a master batch by melt-kneading a binder resin and wax; and melt-kneading a mixture of the master batch, a colorant, and a charge control agent.

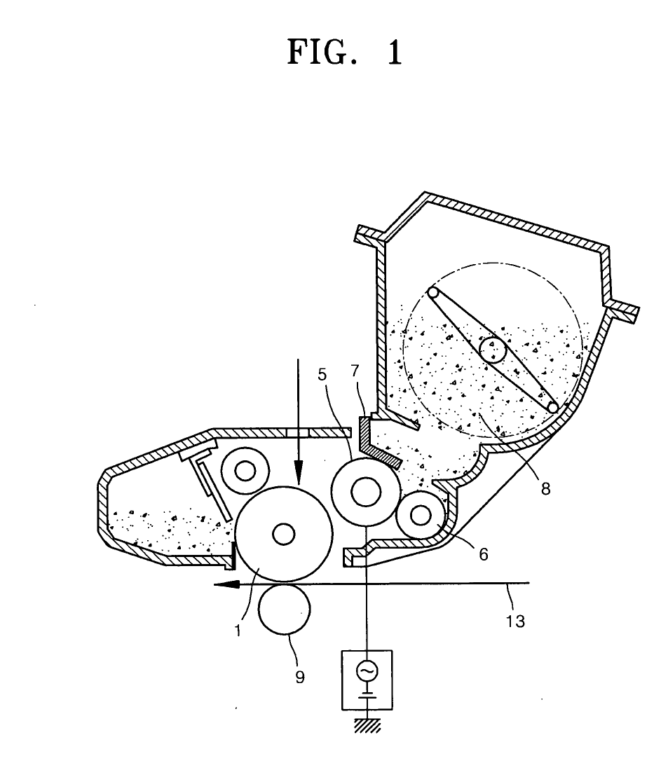

FIG. 1 is a schematic diagram of a non-contact developing type image forming apparatus employing a toner prepared using a method according to an embodiment of the present invention. The operating principles of the image forming apparatus are explained below.

A developer 8, which is a nonmagnetic one-component developer, is supplied to a developing roller 5 through a feeding roller 6 formed of an elastic material such as polyurethane form or sponge. The developer 8 supplied to the developing roller 5 reaches a contact point between the developing roller 5 and a developer regulation blade 7 as the developing roller 5 is rotating. The developer regulation blade 7 is formed of an elastic material such as metal, rubber, and the like. When the developer 8 passes through the contact point between the developing roller 5 and the developer regulation blade 7, the developer 8 is smoothed to form a thin layer and is sufficiently charged. The developing roller 5 transfers the thin layer of the developer 8 to a developing domain where thin layer of the developer 8 is developed on the electrostatic latent image of a photoreceptor 1, which is a latent image carrier.

The developing roller 5 and the photoreceptor 1 face each other with a constant distance therebetween. The developing roller 5 rotates counterclockwise and the photoreceptor 1 rotates clockwise. The thin layer of the developer 8 transferred to the developing domain forms an electrostatic latent image on the photoreceptor 1 according to the intensity of an electric charge generated due to a difference between a voltage applied to the developing roller 5 and a latent image potential of the photoreceptor 1.

The thin layer of the developer 8 developed on the photoreceptor 1 reaches a transferring device 9 as the photoreceptor 1 is rotating. The thin layer of the developer 8 developed on the photoreceptor 1 is transferred through corona discharging or by a roller to a printing paper 13 as the printing paper 13 passes between the photoreceptor 1 and the transferring device 9. The transferring device 9 is charged with a high voltage of an opposite polarity to the developer 8, thereby transferring an image to the printing paper 13.

The printing paper 13 on which the image was transferred passes through a fusing device (not shown) that provides high temperature and high pressure, and the image is fused onto the printing paper 13 as the developer 8 is fused onto the printing paper 13. Meanwhile, the developer 8 remaining on the developing roller 5 and which is not developed is transferred back to the feeding roller 6 that contacts the developing roller 5. The above processes are repeated.

The present invention will now be described in greater detail with reference to the following examples. The following examples are for illustrative purposes only and are not intended to limit the scope of the invention.

### EXAMPLES

The amount of the materials used below is expressed in parts by weight based on 100 parts by weight of untreated parent toner particles.

Materials Used

Binder resin 1: Polyester resin (available from Mitsui Chemical)
Property=>Tg=66˜67° C., T_{1/2}=129.4° C., Mw=20,000

Binder resin 2: Polyester resin (available from Mitsui Chemical)
Property=>Tg=55˜56° C., T_{1/2}=127.4° C., Mw=20,000

Wax: Carnauba wax (available from TOA KASEI)
Property=>Tm=85˜86° C., T_{1/2}=85° C.

Colorant
K: mogul-L
Y: PY 180
M: PR 57:1
C: PB 15:3

Charge control agent (CCA)
Bk: T-77
C,M,Y: E-84

### Example 1

A master batch was prepared with a binder resin 1, a binder resin 2, and wax in the ratio of 48.5:48.5:3 respectively and was kneaded. The master batch was pulverized using a pulverizer so that the size distribution of the master batch was the same as the size distribution of the binder resins. Then the master batch was injected into a kneader to perform a kneading process. The kneading condition of the extrusion kneader was PCM 30 (available from IKEGAI, L/D=31.5, biaxial co-location), and the extruded resin temperature was in the range of 125 to 130° C.

### Comparative Example 1

A binder resin 1, wax, a colorant, and a charge control agent were premixed together and the resultant was injected into a kneader. The kneading condition of the extrusion kneader during the final extrusion kneading was performed in the same manner as in Example 1.

### Comparative Example 2

A binder resin 2, wax, a colorant, and a charge control agent were premixed together and the resultant was injected into a kneader. The kneading condition of the extrusion kneader during the final extrusion kneading was performed in the same manner as in Example 1.

### Comparative Example 3

A master batch was prepared with a binder resin 1 and a binder resin 2 in the ratio of 50:50, and was kneaded. The master batch was pulverized using a pulverizer so that the size distribution of the master batch is the same as the size distribution of the binder resins. Then the master batch was injected into a kneader to perform a kneading process. The kneading condition of the extrusion kneader during the final extrusion kneading was performed in the same manner as in Example 1.

Preparation of Toner Particles

The knead-dispersed intermediate material was pulverized using a mechanical pulverizer (SR-15), and the resultant was classified using a classifier to obtain a toner of D50=8 μm without any external additives. A complete toner was prepared by adding an external additive having the same combination of components as in Example 1, Comparative Examples 1 through 3 to the toner without any external additives.

Confirmation of Wax Dispersibility

Dispersibility of wax was confirmed through image evaluation and fixability evaluation.

<Image Evaluation>

Images were evaluated on background and developing member contamination (especially occurrence of streak when a doctor blade was attached to the toner due to low durability), based on running evaluation under H/H (high humidity) environment.

| | | | Occurrence of |
|---|---|---|---|
| | Background | | doctor blade |
| Evaluation | Initial | 2k Running | streak (point of time) |
| Example 1 | ◯ | ◯ | None |
| Comparative Example 1 | ◯ | Δ | Streak near 1.5k |
| Comparative Example 2 | ◯ | Δ | None |
| Comparative Example 3 | ◯ | ◯ | None |

* Regarding the background, toner contamination in non-image area was measured, based on the measuring person's standard, using a sensory evaluation.
level: ◯ → Good, Δ → Medium, X → Not Good

<Fixability Evaluation>

Fixability was evaluated for each temperature, each process speed, and each paper supplied using a fixing jig. Using the fixing jig, fixability was measured by varying temperatures on the surface of a fusing device, process speeds (150 mm/s), papers (60 g, 75 g, 100 g), colors, and overlaid images. A soft double sided roll of CLP-500 (a color printer) was used as a fusing device. The evaluation results are shown by ◯, Δ, and X, according to the degree of occurrence of cold offset, wrap jam, and hot offset.

◯: Clean image without cold offset, wrap jam, and hot offset.

Δ: Invisible to the naked eye, but in the case of cold offset, colors come off when slightly rubbed with a finger.

X: Occurrence of cold offset, wrap jam, and hot offset.

Result of Fixability Evaluation of Example 1

TABLE 1A
<Solid image> Process speed: 150 mm/s

| | 160° C. | 170° C. | 180° C. | 190° C. |
|---|---|---|---|---|
| Y | | | | |
| 60 g | ◯ | ◯ | ◯ | ◯ |
| 75 g | ◯ | ◯ | ◯ | ◯ |
| 100 g | ◯ | ◯ | ◯ | ◯ |
| M | | | | |
| 60 g | ◯ | ◯ | ◯ | ◯ |
| 75 g | ◯ | ◯ | ◯ | ◯ |
| 100 g | Δ | ◯ | ◯ | ◯ |
| C | | | | |
| 60 g | ◯ | ◯ | ◯ | ◯ |
| 75 g | ◯ | ◯ | ◯ | ◯ |
| 100 g | Δ | ◯ | ◯ | ◯ |
| K | | | | |
| 60 g | ◯ | ◯ | ◯ | ◯ |
| 75 g | ◯ | ◯ | ◯ | ◯ |
| 100 g | ◯ | ◯ | ◯ | ◯ |

TABLE 1B
<Color bar overlay> Process speed: 150 mm/s

| Overlay | 160° C. | 170° C. | 180° C. | 190° C. |
|---|---|---|---|---|
| 60 g | ◯ | ◯ | ◯ | ◯ |
| 75 g | ◯ | ◯ | ◯ | ◯ |
| 100 g | Δ | ◯ | ◯ | ◯ |

Result of Fixability Evaluation of Comparative Example 1

TABLE 2A
<Solid image> Process speed: 150 mm/s

| | 160° C. | 170° C. | 180° C. | 190° C. |
|---|---|---|---|---|
| Y | | | | |
| 60 g | ◯ | ◯ | ◯ | X |
| 75 g | X | Δ | ◯ | ◯ |
| 100 g | X | X | ◯ | ◯ |
| M | | | | |
| 60 g | ◯ | ◯ | ◯ | X |
| 75 g | X | ◯ | ◯ | ◯ |
| 100 g | X | X | ◯ | ◯ |
| C | | | | |
| 60 g | ◯ | ◯ | ◯ | X |
| 75 g | X | Δ | ◯ | ◯ |
| 100 g | X | X | Δ | ◯ |
| K | | | | |
| 60 g | Δ | ◯ | ◯ | ◯ |
| 75 g | X | Δ | ◯ | ◯ |
| 100 g | X | X | Δ | ◯ |

TABLE 2B
<Color bar overlay> Process speed: 150 mm/s

| Overlay | 160° C. | 170° C. | 180° C. | 190° C. |
|---|---|---|---|---|
| 60 g | Δ | ◯ | ◯ | ◯ |
| 75 g | X | X | ◯ | ◯ |
| 100 g | X | X | Δ | ◯ |

Result of Fixability Evaluation of Comparative Example 2

TABLE 3A
<Solid image> Process speed: 150 mm/s

| | 160° C. | 170° C. | 180° C. | 190° C. |
|---|---|---|---|---|
| Y | | | | |
| 60 g | ◯ | ◯ | ◯ | ◯ |
| 75 g | ◯ | ◯ | ◯ | ◯ |
| 100 g | ◯ | ◯ | ◯ | ◯ |
| M | | | | |
| 60 g | ◯ | ◯ | ◯ | ◯ |
| 75 g | ◯ | ◯ | ◯ | ◯ |
| 100 g | ◯ | ◯ | ◯ | ◯ |
| C | | | | |
| 60 g | ◯ | ◯ | ◯ | ◯ |
| 75 g | ◯ | ◯ | ◯ | ◯ |
| 100 g | ◯ | ◯ | ◯ | ◯ |
| K | | | | |
| 60 g | ◯ | ◯ | ◯ | ◯ |
| 75 g | ◯ | ◯ | ◯ | ◯ |
| 100 g | ◯ | ◯ | ◯ | ◯ |

TABLE 3B
<Color bar overlay> Process speed: 150 mm/s

| Overlay | 160° C. | 170° C. | 180° C. | 190° C. |
|---|---|---|---|---|
| 60 g | ◯ | ◯ | ◯ | ◯ |
| 75 g | ◯ | ◯ | ◯ | ◯ |
| 100 g | Δ | ◯ | ◯ | ◯ |

TABLE 4A
<Solid image> Process speed: 150 mm/s

| | 160° C. | 170° C. | 180° C. | 190° C. |
|---|---|---|---|---|
| Y | | | | |
| 60 g | ◯ | ◯ | ◯ | X |
| 75 g | ◯ | ◯ | ◯ | ◯ |
| 100 g | X | ◯ | ◯ | ◯ |
| M | | | | |
| 60 g | ◯ | ◯ | ◯ | X |
| 75 g | ◯ | ◯ | ◯ | ◯ |
| 100 g | X | ◯ | ◯ | ◯ |
| C | | | | |
| 60 g | ◯ | ◯ | ◯ | X |
| 75 g | ◯ | ◯ | ◯ | ◯ |
| 100 g | Δ | ◯ | ◯ | ◯ |
| K | | | | |
| 60 g | ◯ | ◯ | ◯ | ◯ |
| 75 g | ◯ | ◯ | ◯ | ◯ |
| 100 g | X | ◯ | ◯ | ◯ |

TABLE 4B
<Color bar overlay> Process speed: 150 mm/s

| Overlay | 160° C. | 170° C. | 180° C. | 190° C. |
|---|---|---|---|---|
| 60 g | ◯ | ◯ | ◯ | X |
| 75 g | Δ | ◯ | ◯ | X |
| 100 g | X | Δ | ◯ | ◯ |

In Example 1, a toner was prepared by previously preparing a master batch with a binder resin 1 and binder resin 2 having different glass transition temperatures, and wax. The toner did not exhibit image contamination and color bar overlaid image, and exhibited good fixability.

In Comparative Example 1, a toner was prepared using a binder resin 1 having relatively higher glass transition temperature than a binder resin 2. Hot offset occurred in a high temperature and cold offset occurred in a low temperature. In Comparative Example 2, a toner was prepared using a binder resin 2 having relatively lower glass transition temperature than a binder resin 1. Offsets did not occur, but image contamination occurred. In Comparative Example 3, a toner was prepared by preparing a master batch using a binder resin 1 and a binder resin 2. Hot offset occurred at a high temperature and cold offset occurred at a low temperature.

According to the above results, when only a binder resin having a low glass transition temperature was used, image fixability was good but the images may be contaminated. A master batch can be prepared with a binder resin having a high glass transition temperature to prevent image contamination, but a fixing margin is narrow. Thus, a toner can be prepared by preparing a master batch using at least two binder resins having different properties and wax and kneading the master batch to improve fixability and widen the fixing margin.

According to the present invention, paper jam can be decreased and fixing margin can be increased by preventing wax to be dispersed mainly in a resin having similar melting properties as the wax during melt-kneading. Also, an electrophotographic developer, prepared using the method according to the present invention, can prevent image contamination and developing element contamination and guarantee fixing margin of a toner, and thus, can be efficiently used in an electrophotographic image forming apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing a nonmagnetic one-component pulverized color electrophotographic developer, comprising:
preparing a master batch by melt-kneading at least two binder resins and wax; and
melt-kneading a mixture of the master batch, a colorant, and a charge control agent.

2. The method of claim 1, wherein the binder resin comprises at least one material selected from the group consisting of polystyrene, styrene based copolymer, polymethylmethacrylate, polyethylmethacrylate, polybutylmethacrylate, a copolymer thereof, polyvinyl chloride, polyvinyl acetate, polyethylene, polypropylene, polyester, polyurethane, polyamide, epoxy resin, polyvinylbutyral resin, rosin, modified rosin, terpene resin, and phenol resin.

3. The method of claim 1, wherein the at least two binder resins are of the same kind or different kinds.

4. The method of claim 3, wherein when the at least two binder resins are of different kinds of resins, and wherein the two binder resins are included in a ratio of about 1:9 to about 9:1 by weight.

5. The method of claim 1, wherein the glass transition temperatures of the at least two binder resins are the same type or different type.

6. The method of claim 5, wherein when the at least two binder resins have different glass transition temperatures, and wherein the two binder resins are included in a ratio of about 1:9 to about 9:1.

7. The method of claim 1, wherein the wax comprises a material selected from the group consisting of polypropylene, polyethylene, ester, paraffin, and carnauba wax.

8. The method of claim 1, wherein the melting point of the wax is in the range of about 70 to 90° C.

9. The method of claim 1, wherein the amount of wax, used in preparing a master batch, is in the range of about 1 to 10 parts by weight based on the 100 parts by weight of the binder resins used in the master batch.

10. The method of claim 1, wherein the melt-kneading temperature of the preparing a master batch is lower than a softening point of the at least two binder resins and higher than the melting point of the wax.

11. The method of claim 1, wherein the melt-kneading temperature of the mixture of the master batch, colorant and charge control agent is lower than the softening point of the master batch and higher than the melting point of the wax.

12. The method of claim 1, wherein the colorant comprises one material selected from the group consisting of yellow, magenta, cyan and black pigments.

13. An electrophotographic developer prepared using the method of claim 1.

14. An electrophotographic image forming apparatus using the electrophotographic developer of claim 13.

15. The method of claim 1, wherein said master batch is pulverized to obtain a predetermined particle size, and wherein the resulting kneaded mixture of the master batch, colorant and charge control agent is pulverized to produce the color electrophotographic developer.

16. The method of claim 1, further comprising pulverizing the resulting kneaded mixture of the master batch, colorant and charge control agent to produce the developer.

17. The method of claim 1, comprising kneading said mixture of the master batch, colorant and charge control agent at a temperature of about 80° C. to 180° C.

18. The method of claim 1, wherein said master batch is prepared by melt-kneading a mixture of said at least two binder resins and adding said wax during said melt-kneading step.
